(19) United States
(12) Patent Application Publication
(10) Pub. No.: US 2007/0169793 A1
(43) Pub. Date: Jul. 26, 2007

(54) SUBSTRATE TREATMENT APPARATUS AND SUBSTRATE TREATMENT METHOD

(76) Inventors: Kumiko Shimada, Kyoto (JP); Masanobu Sato, Kyoto (JP)

Correspondence Address: OSTROLENK FABER GERB & SOFFEN, 1180 AVENUE OF THE AMERICAS, NEW YORK, NY, 100368403, US

(21) Appl. No.: 11/626,673

(22) Filed: Jan. 24, 2007

(30) Foreign Application Priority Data
Jan. 26, 2006 (JP) 2006-017967
Oct. 30, 2006 (JP) 2006-294470

(51) Int. Cl. B08B 3/00

(52) U.S. Cl. 134/26

(57) ABSTRACT

The substrate treatment apparatus includes a substrate holder mechanism for holding a substrate to be treated, and a bifluid nozzle for supplying liquid droplets on a surface of the substrate held by the substrate holder mechanism. The bifluid nozzle has a casing, a liquid outlet port for discharging a treatment liquid, and gas outlet port for discharging a gas, and is adapted to introduce the treatment liquid and the gas into the casing, to generate droplets of the treatment liquid by mixing the treatment liquid discharged from the liquid outlet port with the gas discharged from the gas outlet port outside the casing, and to supply the liquid droplets on the substrate. The density of the liquid droplets supplied from the bifluid nozzle on the substrate surface is not less than 10⁸ droplets/m² per minute.

### BACKGROUND OF THE INVENTION

1. Field of the Invention

The present invention relates to a substrate treatment apparatus and a substrate treatment method for conducting a cleaning processing or the like on a surface of a substrate. Examples of the substrate to be treated include semiconductor wafers, substrates for liquid crystal display devices, substrates for plasma display devices, substrates for FED (Field Emission Display), substrates for optical disks, substrates for magnetic disks, substrates for magneto-optical disks, and substrates for photo-masks.

2. Description of Related Art

In a semiconductor device production process, a cleaning processing for removing foreign matter (particles, etc.) from a surface of a semiconductor wafer (hereinafter referred to as “wafer”) is indispensable. Some substrate treatment apparatuses for cleaning a wafer surface comprise a bifluid nozzle adapted to generate droplets of a treatment liquid (cleaning liquid) by mixing the treatment liquid with gas so as to spout the droplets therefrom (see U.S. 2002/0059947 A1, for example).

FIG. 9 is a schematic sectional view illustrating the construction example of the bifluid nozzle. This bifluid nozzle 51 includes an outer cylinder 52 serving as a casing, and an inner cylinder 53 fitted in the outer cylinder 52. The outer cylinder 52 and the inner cylinder 53 each have a generally cylindrical shape, and have a common center axis. The inside space of the inner cylinder 53 serves as a treatment liquid channel 56, and deionized water as the treatment liquid (cleaning liquid) can be introduced into the treatment liquid channel 56 from the upper end of the inner cylinder 53. The treatment liquid channel 56 has an opening at its lower end as a treatment liquid outlet port 57 being oriented downward.

On the other hand, a generally cylindrical space serving as a gas channel 54 is defined between the inner cylinder 53 and the outer cylinder 52. The gas channel 54 has an opening at its lower end as an annular gas outlet port 58 around the treatment liquid outlet port 57. The gas channel 54 is in communication with a gas inlet pipe 55 extending through the outer cylinder 52, so that high-pressure nitrogen gas is introduced thereinto through this gas inlet pipe 55.

When the deionized water and the nitrogen gas are simultaneously introduced into the treatment liquid channel 56 and the gas channel 54, respectively, the deionized water and the nitrogen gas are discharged from the treatment liquid outlet port 57 and the gas outlet port 58, respectively. These deionized water and nitrogen gas are discharged from the treatment liquid outlet port 57 and the gas outlet port 58, respectively, and are collided (mixed) with each other in the vicinity of their outlet ports, whereby droplets of the deionized water are generated. Such droplets turn into a jet flow to impinge on a surface of a wafer W disposed below. At this time, foreign matter such as particles adhering to the surface of the wafer W is physically removed by the kinetic energy of the deionized water droplets.

Spray cleaning by a bifluid nozzle causes less damage to a substrate (particularly damage to a pattern formed on a surface of a substrate), as compared with other physical cleaning processing such as brush cleaning or ultrasonic cleaning. Therefore, it is a promising alternative for cleaning a surface of a substrate having a fine pattern formed thereon with suppression of damage.

However, the spray cleaning by the bifluid nozzle still causes damage to a substrate. As a further finer pattern is formed on a surface of a substrate, further suppression of damage is required.

### SUMMARY OF THE INVENTION

It is an object of the present invention to provide a substrate treatment apparatus and a substrate treatment method each achieving further suppression of damage during the substrate treatment using a bifluid nozzle.

In order to suppress damage to a pattern on a surface of a substrate, it is first considered that a flow rate of gas charged into the bifluid nozzle is reduced, thereby lowering the speed of liquid droplets jetted from the bifluid nozzle. However, the reduction in the flow rate of the gas charged results in the greater diameter of the generated liquid droplets, which leads to a corresponding decrease in the droplet density. This is not effective in suppression of the damage to the pattern on the substrate surface. Moreover, the foreign matter removing capability deteriorates, because the low density of the liquid droplets results in a lower probability that the liquid droplets impinge on foreign matters on the substrate.

As a result of intensive studies on substrate cleaning by a bifluid nozzle, the present inventors have found that droplet density is deeply related to the foreign matter removing capability. The present invention has been accomplished thereby.

That is, according to one aspect of the present invention, a substrate treatment apparatus comprises a substrate holder mechanism for holding a substrate to be treated, and a bifluid nozzle. The bifluid nozzle has a casing, a liquid outlet port for discharging a treatment liquid, and a gas outlet port for discharging gas, and is adapted to introduce the treatment liquid and the gas into the casing, to generate droplets of the treatment liquid by mixing the treatment liquid discharged from the liquid outlet port with the gas discharged from the gas outlet port (by impinging the gas on the liquid) outside the casing (in the vicinity of the liquid outlet port), and to supply the liquid droplets on a surface of a substrate held by the substrate holder mechanism. The density of the liquid droplets (droplet density) supplied from the bifluid nozzle on the substrate surface is not less than 10⁸ droplets/m² per minute (more preferably not less than 1.2×10⁸ droplets/m² per minute, even more preferably not less than 5×10⁸ droplets/m² per minute nor more than 8×10⁸ droplets/m² per minute).

With this arrangement, micro liquid droplets can be generated by an external mixing type nozzle for mixing as and a liquid outside the casing to generate a jet of droplets. The density of the liquid droplets on the surface of the substrate held by the substrate holder mechanism is not less than 10⁸ droplets/m² per minute (density in which 10⁸ droplets reach an unit region of 1 square millimeter for 1 minute), whereby excellent foreign matter removing performance can be obtained as shown in the test results to be described later. That is, even when the gas flow rate is reduced in order to suppress the damage to the pattern on the substrate surface, the necessary foreign matter removing performance can be achieved by controlling the droplet density in the aforesaid range. Accordingly, cleaning processing with suppression of damage and excellent in foreign matter removing performance can be achieved, whereby a substrate having an ultrafine pattern formed thereon can be advantageously cleaned.

The upper limit of the droplet density on the substrate surface is, for example, 10⁹ droplets/m² per minute. This upper limit value is determined mainly from the constitutional limit of the external mixing type bifluid nozzle.

The treatment liquid may be, for example, deionized water, and other examples thereof may be chemical agents such as a mixture of ammonia, hydrogen peroxide, and water.

The gas outlet port may be in the form of an annular shape surrounding the liquid outlet port. In this case, the gas outlet port of the annular shape preferably has an outer diameter of not less than 2 mm nor more than 3.5 mm and a width of not less than 0.05 mm nor more than 0.2 mm (more preferably not less than 0.05 mm nor more than 0.15 mm).

The substrate treatment apparatus preferably further comprises a gas supplying mechanism for supplying the gas to the casing at a flow rate of not more than 17 liters per minute. By supplying the gas at such a small flow rate, the speed of the liquid droplet when impinging on a substrate can be suppressed, whereby the damage to the pattern on the substrate surface can be reduced. Besides, high droplet density can provide sufficient foreign matter removing performance. Thus, while both of the foreign matter removing capability and the suppression of the damage are satisfied, the foreign matter removing processing can be performed on the substrate surface.

According to another aspect of the present invention, a substrate treatment apparatus comprises a substrate holder mechanism for holding a substrate to be treated, and a bifluid nozzle. The bifluid nozzle has a casing, a liquid outlet port for discharging a treatment liquid, and a gas outlet port for discharging gas, and is adapted to introduce the treatment liquid and the gas into the casing, to generate droplets of the treatment liquid by mixing the treatment liquid discharged from the liquid outlet port with the gas discharged from the gas outlet port (by impinging the gas on the liquid) outside the casing, and to supply the liquid droplets on a surface of a substrate held by the substrate holder mechanism. The gas outlet port is in the form of an annular shape surrounding the liquid outlet port. This gas outlet port of the annular shape has an outer diameter of not less than 2 mm nor more than 3.5 mm and a width of not less than 0.05 mm nor more than 0.2 mm (more preferably not less than 0.05 mm nor more than 0.15 mm).

In the external mixing type bifluid nozzle that the assignee of the present invention has proposed prior to the present application, the gas outlet port of an annular shape surrounding the liquid outlet port in the center of the nozzle is defined, for example, with an outer diameter of 3.5 mm and a width of 0.3 mm. According to the test results on the bifluid nozzle having such arrangement, the droplet density required to obtain a desired foreign matter removing performance (for example, 50% of removal ratio) is about 8×10⁷. In this case, the gas flow rate is large, and therefore, the damage to the pattern on the substrate surface is relatively high. If the gas flow rate is reduced, the damage will be suppressed. However, each liquid droplet becomes large, and as a result, the required droplet density cannot be obtained.

In contrast, with the bifluid nozzle having a gas outlet port designed as described above, charging the gas at a relatively small flow rate enables generation of liquid droplets having small diameters. Therefore, the droplet density required to obtain a desired removing performance (for example, not less than 10⁸ droplets/m² per minute) can be easily achieved. That is, by making the bifluid nozzle itself smaller, liquid droplets having small diameters can be generated even at a smaller gas flow rate, whereby the required droplet density can be achieved. Thus, while the damage to the pattern on the substrate is suppressed, the foreign matter on the substrate surface can be effectively removed.

The bifluid nozzle is preferably disposed at a position spaced less than 20 mm apart from the surface of the substrate held by the substrate holder mechanism when droplets of the treatment liquid are supplied to the substrate. With this arrangement, less than 20 mm of the distance between the bifluid nozzle and the substrate surface can keep the droplet density on the substrate surface high. More specifically, this arrangement can suppress or prevent the liquid droplets from coming in contact with one another to combine into larger droplets before reaching the substrate surface from the bifluid nozzle. At the same time, there can be suppressed or prevented such that the flow of the droplets spreads over a larger cleaning area, which in turn decreases the droplet density. This allows liquid droplets having small diameters to reach a small area region on the substrate surface, whereby the droplet density on the substrate surface can be increased. The distance between the bifluid nozzle and the substrate surface refers to the distance between the substrate surface and the mixing point of the treatment liquid discharged from the liquid outlet port and the gas discharged from the gas outlet port.

The substrate treatment apparatus preferably further comprises a controller for controlling flow rates of the treatment liquid and the gas each supplied to the casing and the distance between the bifluid nozzle and the substrate surface (more specifically, the distance between the mixing point of the treatment liquid discharged from the liquid outlet port with the gas discharged from the gas outlet port, and the substrate surface). This controller preferably controls the flow rates of the treatment liquid and the gas, and the distance between the bifluid nozzle and the substrate surface so that the density of the liquid droplets supplied from the bifluid nozzle on the substrate surface (droplet density) is not less than 10⁸ droplets/m² per minute (preferably not less than 1.2×10⁸ droplets/m² per minute, and the upper limit value of, for example, 10⁹ droplets/m²).

With this arrangement, the droplet density on the substrate surface can be controlled to not less than 10⁸ droplets/m² per minute with a small amount of gas charged, whereby substrate cleaning processing can be achieved with suppression of damage to the pattern on the substrate surface.

The controller is preferably adapted to, for example, control the flow rate of the treatment liquid charged into the casing to be in the range of 100 ml/min, and the flow rate of the gas charged into the casing to be in the range of 10 to 20 liters/min (preferably 13 to 17 liters/min, and more preferably about 16 liters/min). Furthermore, the controller is preferably adapted to control the distance between the bifluid nozzle and the substrate surface to be in the range of 2 to 15 mm (more preferably 3 to 10 mm, and even more preferably 3 to 7 mm).

The volume median diameter of the liquid droplets supplied from the bifluid nozzle is preferably not more than 25 μm (preferably not more than 20 μm).

The volume median diameter is a measure of particle size of the liquid droplet indicated by the volume of the liquid sprayed. Specifically, when the sum of the volumes of liquid droplets having diameters greater than a certain diameter accounts for 50% of the total volume of all the observed liquid droplets (that is, the sum of the volumes of liquid droplets having diameters smaller than the certain diameter accounts for 50% of the total volume of all the observed liquid droplets), the diameter is called a volume median diameter.

The volume median diameter in the aforesaid range makes it possible to suppress damage to the pattern formed on the substrate surface thereby to sufficiently increase the droplet density on the substrate surface. Therefore, the excellent foreign matter removing performance can be obtained.

The reach region (cleaning region) of the liquid droplets supplied from the bifluid nozzle on the substrate surface has a diameter of preferably not less than 5 mm nor more than 15 mm (more preferably not less than 6 mm nor more than 13 mm, and even more preferably not less than 6 mm nor more than 8 mm). The circular cleaning region has an area of 19.6 m² when having a diameter of 5 mm; 28.3 m² when having a diameter of 6 mm; 50.2 m² when having a diameter of 8 mm; 132.7 m when having a diameter of 13 mm; and 176.6 m² when having a diameter of 15 mm.

With this arrangement, the reach region of the liquid droplets is sufficiently reduced, so that the droplet density on the substrate surface can be increased. Thus, the foreign matter removing performance can be enhanced.

The bifluid nozzle preferably has a spiral flow generating portion provided in the gas channel leading from a gas inlet port to the gas outlet port, so as to generate a spiral flow which sheathes a treatment liquid flow discharged from the treatment liquid outlet port along the treatment liquid discharging direction. With this arrangement, spreading of the gas discharged from the gas outlet port can be suppressed, so that the treatment liquid and the gas are efficiently mixed with each other. Therefore, micro liquid droplets can be efficiently generated. Thus, the damage to a substrate can be further suppressed.

The substrate treatment method of the present invention comprises the steps of introducing a treatment liquid into a casing of a bifluid nozzle; introducing gas into a casing of the bifluid nozzle; generating droplets of the treatment liquid by discharging the gas from a gas outlet port of the bifluid nozzle while the liquid is discharged from a liquid outlet port of the bifluid nozzle, and mixing the discharged gas and liquid; and supplying the generated liquid droplets on a surface of a substrate, to provide a droplet density on the substrate surface of not less than 10⁸ droplets/m² per minute (more preferably not less than 1.2×10⁸ droplets/m² per minute, and for example, an upper limit value of 10⁹ droplets/m² per minute). According to this method, cleaning processing with suppression of damage and excellent in a foreign matter removing performance can be achieved, whereby a substrate having an ultrafine pattern formed thereon can be advantageously cleaned.

The step of introducing gas into the casing of the bifluid nozzle preferably includes the step of supplying the gas to the casing at a flow rate of not more than 17 liters/min. According to this method, the speed of the liquid droplet at a time of impinging on a substrate can be suppressed, whereby the damage to the pattern on the substrate surface can be reduced. Furthermore, since the droplet density is high, the foreign matter removing performance can be sufficiently achieved. Thus, while both of the foreign matter removing capability and the suppression of the damage are satisfied, the foreign matter removing processing on the substrate surface can be performed.

These and other features, objects, advantages and effects of the present invention will be more fully apparent from the following detailed description of embodiments set forth below when taken in conjunction with the accompanying drawings.

### BRIEF DESCRIPTION OF THE DRAWINGS

FIG. 1 is a schematic side view illustrating the construction of a substrate treatment apparatus according to one embodiment of the present invention.

FIG. 2A is a schematic sectional view illustrating the construction of a bifluid nozzle, and FIG. 2B is a bottom view of the bifluid nozzle.

FIGS. 3(a) and 3(b) are a schematic partial side view and a schematic bottom view, respectively, of an inner cylinder.

FIG. 4 is a schematic perspective view illustrating the flow directions of nitrogen gas discharged from a gas outlet port of the bifluid nozzle.

FIG. 5 is a schematic perspective view illustrating the flow directions of nitrogen gas discharged from the gas outlet port of the bifluid nozzle.

FIGS. 6(a) and 6(b) illustrate relationships between the droplet density and the number of patterns damaged on a wafer.

FIGS. 7(a) and 7(b) illustrate relationships between the nozzle height and the number of patterns damaged on a wafer as for the bifluid nozzle used in Comparative Example.

FIGS. 8(a) and 8(b) illustrate relationships between the nozzle height and the number of patterns damaged on a wafer as for the bifluid nozzle used in Examples 1 and 2, respectively.

FIG. 9 is a schematic sectional view illustrating the construction of a bifluid nozzle provided in a conventional substrate treatment apparatus.

### DETAILED DESCRIPTION OF PREFERRED EMBODIMENTS

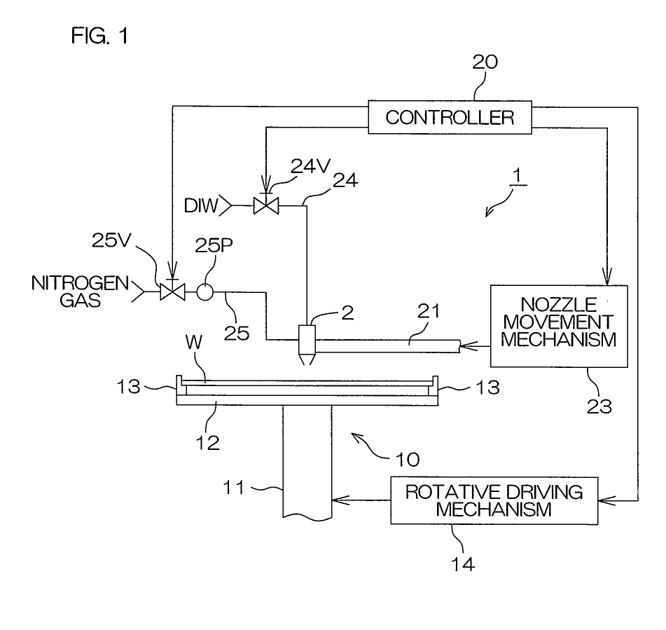

FIG. 1 is a schematic side view illustrating the construction of a substrate treatment apparatus according to one embodiment of the present invention. This substrate treatment apparatus 1 is adapted to clean a surface of a semiconductor wafer (hereinafter referred to simply as “wafer”) W as an example of a substrate, and includes a spin chuck 10 as a substrate holder mechanism which rotates while generally horizontally holding a wafer W and a bifluid nozzle 2 which supplies droplets of deionized water (deionized water), which is a cleaning liquid, to the wafer W held by the spin chuck 10.

The spin chuck 10 includes a rotation shaft 11 disposed vertically and a disk-shaped spin base 12 generally horizontally attached to an upper end of the rotation shaft 11. A plurality of chuck pins 13 are provided upright on a peripheral portion of the upper face of the spin base 12 in circumferentially properly spaced relation. The chuck pin 13 is adapted to support a peripheral portion of a lower surface of the wafer W and cooperatively hold the wafer W with other chuck pins 13, in abutment against an edge (circumferential surface) of the wafer W. The wafer W is generally horizontally held by the spin chuck 10 with the center thereof aligned with the center axis of the rotation shaft 11.

A rotative driving mechanism 14 is coupled to the rotation shaft 11, and is capable of rotating the rotation shaft 11 about the center axis thereof. Thus, the wafer W held by the spin chuck 10 can be rotated.

The bifluid nozzle 2 is adapted to be supplied with deionized water as an example of a treatment liquid from a deionized water supply source through a treatment liquid pipe 24. The treatment liquid pipe 24 is provided with an opening-adjustable valve 24V for opening and closing the flow path of the deionized water supplied to the bifluid nozzle 2 and adjusting the flow rate of the deionized water.

The bifluid nozzle 2 is further adapted to be supplied with high-pressure nitrogen gas (an example of gas) from a nitrogen gas supply source through a nitrogen gas pipe 25. The nitrogen gas pipe 25 is provided with an opening-adjustable valve 25V for opening and closing the flow path of the nitrogen gas supplied to the bifluid nozzle 2 and adjusting the flow rate of the nitrogen gas. A pressure meter 25P is provided downstream of the valve 25V (between the valve 25V and the bifluid nozzle 2) in the nitrogen gas pipe 25, and is capable of measuring the pressure of the nitrogen gas introduced into the bifluid nozzle 2.

The bifluid nozzle 2 is coupled to a nozzle movement mechanism 23 via an arm 21. The nozzle movement mechanism 23 is adapted to pivot the arm 21 about a pivot axis extending vertically, whereby the bifluid nozzle 2 coupled to the arm 21 can be moved above the wafer W, and further, the distance between the bifluid nozzle 2 and the wafer W (height of the bifluid nozzle 2 with respect to the surface of the wafer W) can be changed by raising and lowering the arm 21. Thus, the position of the treatment performed by the bifluid nozzle 2 can be shifted to each portion from the center to the peripheral edge of the wafer W held by the spin chuck 10, and the distance between the bifluid nozzle 2 and the wafer W can also be adjusted.

When the valves 24V and 25V are simultaneously opened, and then, deionized water and nitrogen gas are simultaneously introduced into the bifluid nozzle 2, a jet flow of the deionized water droplets is generated by the bifluid nozzle 2, and is spouted downward toward the upper surface of the wafer W held by the spin chuck 10.

The opening and closing of the valves 24V and 25V, and the operations of the rotative driving mechanism 14 and the nozzle movement mechanism 23 can be controlled by a controller 20.

To clean the surface of a wafer W, the wafer W held by the spin chuck 10 is rotated by the rotative driving mechanism 14, and droplets of deionized water is spouted toward the upper surface of the wafer W from the bifluid nozzle 2 while the bifluid nozzle 2 is moved horizontally (in the rotation radial direction of the wafer W) above the wafer W by the nozzle movement mechanism 23. Meanwhile, the bifluid nozzle 2 is horizontally moved between a position opposed to the center of the wafer W and a position opposed to the peripheral edge of the wafer W while keeping the height from the surface of the wafer W constant. Thus, the entire upper surface of the wafer W is uniformly treated.

By introducing the high-pressure nitrogen gas into the bifluid nozzle 2, the deionized water droplets with a great kinetic energy are caused to impinge on the surface of the wafer W. At this time, particles adhering on the surface of the wafer W are physically removed by the kinetic energy of the deionized water droplets.

By changing the extent to which the valve 25V opens to change the pressure (flow rate) of the nitrogen gas introduced into the bifluid nozzle 2, the diameter of the deionized water droplets generated by the bifluid nozzle 2 can be changed. Accordingly, the droplet density on the surface of the wafer W (the number of droplets which reaches a unit area region per unit time) can be changed. Thus, the treatment properties of the wafer W by the deionized water droplets can be changed.

Further, by changing the height of the bifluid nozzle 2 with respect to the surface of the wafer W, there can be changed the size (area) of the reach region (treatment region; a generally circular cleaning region according to this embodiment) obtained when a jet flow of the liquid droplets guided onto the surface thereof reaches the wafer W with spreading from the bifluid nozzle 2. Thus, the droplet density on the surface of the wafer W can be adjusted.

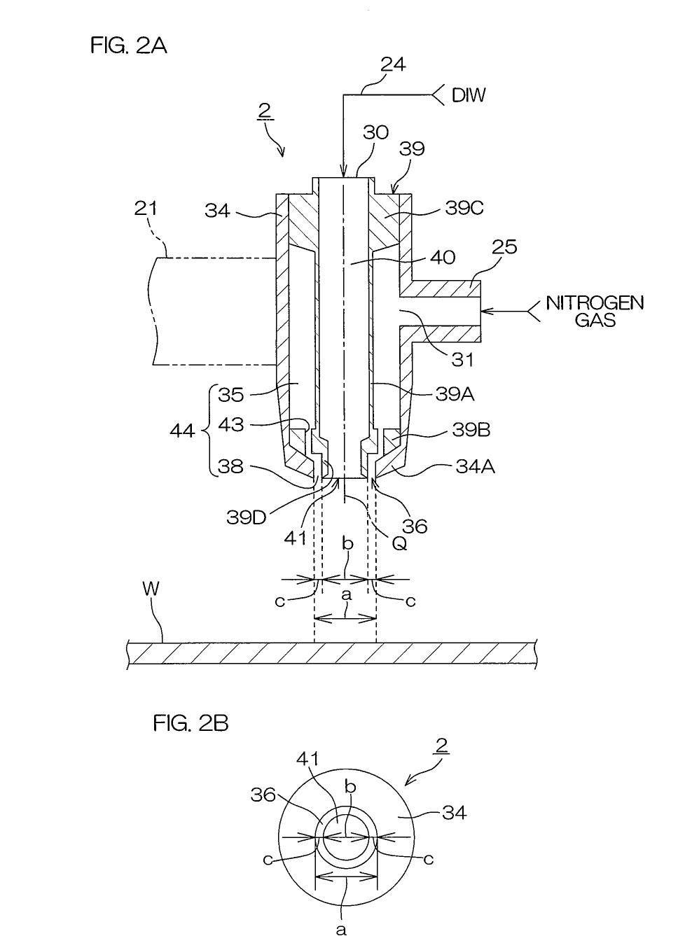

FIG. 2A is a schematic sectional view illustrating the construction of a bifluid nozzle 2, and FIG. 2B is a bottom view of the bifluid nozzle 2 viewed from a spin chuck 10. The bifluid nozzle 2 is of a so-called external mixing type, which is adapted to collide nitrogen gas with deionized water outside a casing thereof to generate droplets of a treatment liquid. The bifluid nozzle 2 includes an outer cylinder 34 serving as a casing, and an inner cylinder 39 fitted in the outer cylinder 34, and has a generally columnar exterior. The inner cylinder 39 and the outer cylinder 34 are disposed coaxially about a common center axis Q.

The inside space of the inner cylinder 39 serves as a linear treatment liquid channel 40. The treatment liquid channel 40 has an opening as a treatment liquid inlet port 30 at one end of the inner cylinder 39. A treatment liquid pipe 24 is connected to one end of the inner cylinder 39, so that deionized water is introduced into the treatment liquid channel 40 from the treatment liquid pipe 24 through the treatment liquid inlet port 30. The treatment liquid channel 40 has an opening as a treatment liquid outlet port 41 at the other end of the inner cylinder 39 (opposite to the end thereof connected to the treatment liquid pipe 24).

The flow path of the deionized water is limited linearly along the center axis Q by the inner cylinder 39, so that the deionized water is discharged from the treatment liquid outlet port 41 along the linear axis (center axis Q). In the treatment of the wafer W, the bifluid nozzle 2 is disposed with its center axis Q being perpendicular to the surface of the wafer W.

The outer cylinder 34 has a generally constant inner diameter. On the other hand, the inner cylinder 39 has an outer diameter differing at each portion along the center axis Q. An intermediate portion 39A of the inner cylinder 39 has an outer diameter smaller than the inner diameter of the outer cylinder 34.

The inner cylinder 39 has flanges 39B, 39C which are respectively provided integrally therewith in the vicinity of the opposite ends thereof as projecting from the outer circumferential surface thereof. The flanges 39B, 39C each have an outer diameter virtually equal to the inner diameter of the outer cylinder 34. Therefore, the circumferential portions of the flanges 39B, 39C of the inner cylinder 39 intimately contact the interior wall of the outer cylinder 34, and a generally cylindrical space serving as a cylindrical channel 35 is defined around the center axis Q between the intermediate portion 39A of the inner cylinder 39 and the interior wall of the outer cylinder 34.

A gas inlet port 31 is provided in a longitudinally middle portion of the outer cylinder 34 in communication with the cylindrical channel 35. On the peripheral surface of the outer cylinder 34, the nitrogen gas pipe 25 is connected to the portion where the gas inlet port 31 is provided. The inside space of the nitrogen gas pipe 25 and the cylindrical channel 35 communicate with each other, so that the nitrogen gas can be introduced into the cylindrical channel 35 from the nitrogen gas pipe 25 through the gas inlet port 31.

A gas flow deflecting channel 43 extending through the flange 39B along the center axis Q is provided in the flange 39B of the inner cylinder 39 provided on the side of the treatment liquid outlet port 41.

An end portion of the outer cylinder 34 on the side of the treatment liquid outlet port 41 serves as a block portion 34A which has a tapered interior wall surface having an inner diameter progressively decreasing toward the end. A short cylindrical portion 39D projects from an end of the flange 39B along the center axis Q. The short cylindrical portion 39D is disposed generally centrally of the block portion 34A. The block portion 34A has an inner diameter greater than the outer diameter of the short cylindrical portion 39D. Therefore, a generally cylindrical space surrounding the center axis Q serving as a whirl flow generating channel 38 is defined between the block portion 34A and the short cylindrical portion 39D.

The cylindrical channel 35, the gas flow deflecting channel 43, and the whirl flow generating channel 38 are communicated with one another to constitute a gas channel 44. The whirl flow generating channel 38 has an annular opening as a gas outlet port 36 around the treatment liquid outlet port 41. With this arrangement, the nitrogen gas introduced into the cylindrical channel 35 through the nitrogen gas pipe 25 is discharged from the gas outlet port 36. The gas flow deflecting channel 43 is disposed in the vicinity of the gas outlet port 36.

In the substrate treatment apparatus 1, the bifluid nozzle 2 is disposed with the treatment liquid outlet port 41 and the gas outlet port 36 being oriented (downward) toward the wafer W held by the spin chuck 10 when the wafer W is cleaned. The treatment liquid outlet port 41 and the gas outlet port 36 are disposed adjacent to each other. More specifically, the treatment liquid outlet port 41 has an circular opening, and the gas outlet port 36 has an annular opening around the treatment liquid outlet port 41.

The annular gas outlet port 36 has an outer diameter a of 2 mm to 3.5 mm, and a width c of 0.05 mm to 0.2 mm. The circular treatment liquid outlet port 41 has a diameter b (=a−2c, which is equal to the inner diameter of the gas outlet port 36) of 1.6 mm to 3.4 mm. More preferably, each of the sizes may be set in each of the numerical ranges of a=2.10 mm to 2.65 mm, b=2.00 mm to 2.35 mm, and c=0.05 mm to 0.15 mm. Specifically, as hereafter described in Example 1 in which the present inventors have performed as a trial test, the sizes are set to a=2.20 mm, b=2.10 mm, and c=0.05 mm. In Example 2, the sizes are set to a=2.50 mm, b=2.30 mm, and c=0.10 mm.

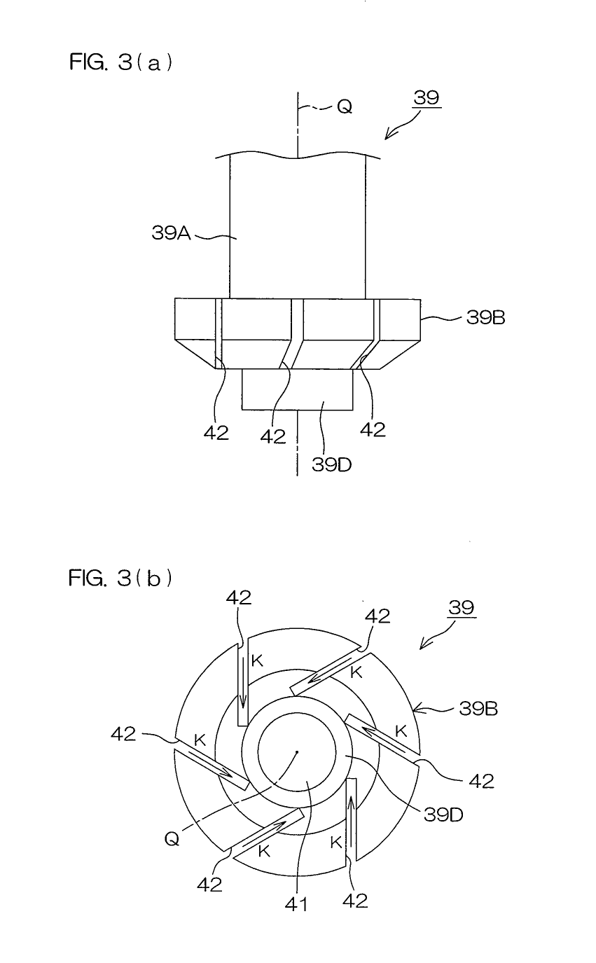

FIGS. 3(a) and 3(b) are a schematic partial side view and a schematic bottom view, respectively, of an inner cylinder 39. In FIG. 3 (a), only the portion adjacent to the flange 39B is illustrated.

The flange 39B has an umbrella-like shape, and projects laterally outward generally perpendicularly to the center axis Q. The flange 39B is formed with six slits 42. Each of the slits 42 is generally equiangularly arranged in spaced relation with one another as respectively extending inward from the outer circumference of the flange 39B within planes generally parallel to the center axis Q and exclusive of the center axis Q.

The slits 42 respectively obliquely intersect radial lines extending from open ends thereof on the outer circumference of the flange 39B to the center axis Q at substantially the same angle, and extend tangentially of the outer circumference of the short cylindrical portion 39D, as viewed along the center axis Q (see FIG. 3 (b)). Therefore, the slits 42 extend tangentially of the gas outlet port 36 (whirl flow generating channel 38) as viewed along the center axis Q in the bifluid nozzle 2.

In the bifluid nozzle 2, the ends of the slits 42 on the outer circumference are closed by the interior wall of the outer cylinder 34, whereby six gas flow deflecting channels 43 are defined. Open portions of the slits 42 disposed circumferentially of the flange 39B on the side of the short cylindrical portion 39D are covered with the block portion 34A (see FIG. 2). On the other hand, inward portions of the slits 42 are overlapped with the gas outlet port 36 as viewed along the center axis Q.

As described above, the bifluid nozzle 2 having the gas flow deflecting channels 43 formed therein can be provided simply by inserting the inner cylinder 39 having the slits 42 formed in the periphery thereof into the outer cylinder 34.

When the nitrogen gas is introduced into the cylindrical channel 35 from the nitrogen gas pipe 25, the nitrogen gas flows through the cylindrical channel 35 along the generating line of the cylindrical channel 35 toward the gas flow deflecting channels 43, and is guided into the gas flow deflecting channels 43. A part of the nitrogen gas flowing through the gas flow deflecting channels 43 in the vicinity of the outer circumference of the flange 39B flows inwardly of the flange 39B along the interior wall of the block portion 34A on the side of the whirl flow generating channel 38 (the nitrogen gas flow directions are indicated by arrows K in FIG. 3(b)). At this time, the nitrogen gas flowing along the generating line of the gas channel 44 is deflected into a direction such that the flow of the nitrogen gas has a component directed circumferentially of the gas channel 44 (whirl flow generating channel 38).

In the whirl flow generating channel 38, the nitrogen gas can freely flow circumferentially of the whirl flow generating channel 38. Therefore, the nitrogen gas introduced into the whirl flow generating channel 38 from the gas flow deflecting channels 43 flows counterclockwise around the center axis Q (around the treatment liquid channel 40) as seen in FIG. 3(b), and is guided to the gas outlet port 36.

With the provision of the six gas flow deflecting channels 43, the deflected gas flows are guided from six circumferentially spaced portions of the generally cylindrical gas channel 44 into the whirl flow generating channel 38 (toward the gas outlet port 36). Thus, a whirl flow is generated uniformly circumferentially of the whirl flow generating channel 38 (in a whirling direction).

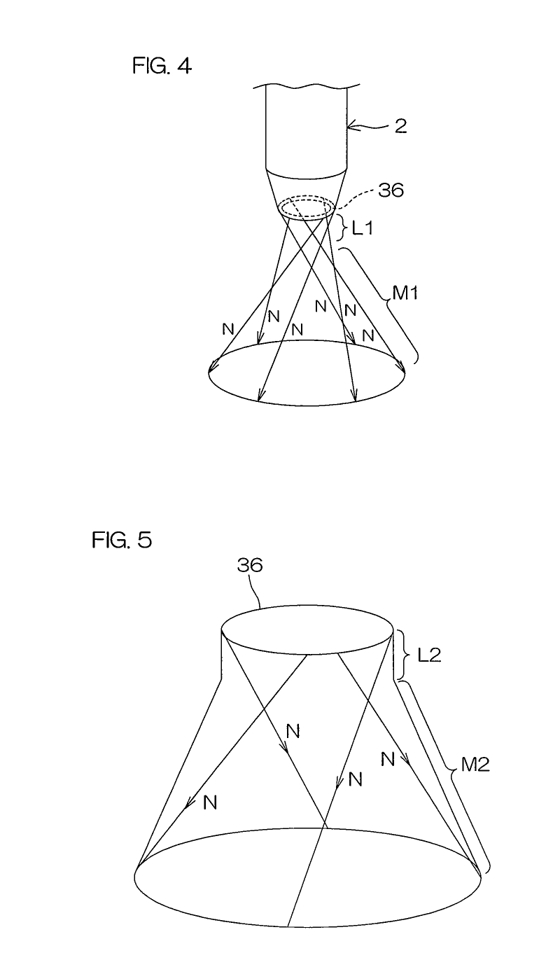

FIG. 4 is a schematic perspective view illustrating the flow directions of nitrogen gas discharged from a gas outlet port 36 of the bifluid nozzle 2. In FIG. 4, the flow directions of the nitrogen gas are indicated by arrows N. The nitrogen gas flows as whirling around the treatment liquid channel 40 in the whirl flow generating channel 38, whereby the nitrogen gas discharged from the gas outlet port 36 generates a spiral flow in the vicinity of the gas outlet port 36. The nitrogen gas is discharged from the gas outlet port 36 after the whirl flow is generated in the whirl flow generating channel 38. Therefore, the spiral flow is circumferentially uniform. The spiral flow of the nitrogen gas is generated so as to sheathe the deionized water discharged from the treatment liquid outlet port 41 along the center axis Q.

Since the slits 42 are provided as extending tangentially of the gas outlet port 36 as viewed along the center axis Q, the nitrogen gas discharged from the gas outlet port 36 flows in a direction such that the gas flow has a component directing tangentially of the gas outlet port 36. Therefore, the flow of the deionized water droplets carried together with the nitrogen gas from the bifluid nozzle 2 onto the wafer W has a contour which has a narrow portion L1 formed in the vicinity of the treatment liquid outlet port 41 and a divergent portion M1 diverging from the narrow portion L1 toward the surface of the wafer W held by the spin chuck 10.

The narrow portion L1 has a shape (generally inverted truncated conical shape) such that the area of a cross section (diameter of a generally round cross section) thereof taken perpendicularly to the deionized water discharging direction decreases at each portion along the deionized water discharging direction toward the wafer W held by the spin chuck 10. The divergent portion M1 is continuous from an end of the narrow portion L1 on the side of the spin chuck 10, and has a shape (generally truncated conical shape) such that the area of a cross section (diameter of a generally round cross section) thereof taken perpendicularly to the deionized water discharging direction increases toward the spin chuck 10. Therefore, a shape like a Japanese hand drum is formed with the narrow portion L1 and the divergent portion M1.

The major flow direction of the deionized water droplets spouted from the bifluid nozzle 2 (the center axis of the spiral flow) is generally perpendicular to the wafer W.

FIG. 5 is a schematic perspective view illustrating another example of the flow directions of nitrogen gas discharged from a gas outlet port 36 of the bifluid nozzle 2. In FIG. 5, the flow directions of the nitrogen gas are indicated by arrows N. The flow of the deionized water droplets carried together with the nitrogen gas from the bifluid nozzle 2 onto the wafer W has a contour which has a narrow portion L2 formed in the vicinity of the treatment liquid outlet port 41 and a divergent portion M2 diverging from the narrow portion L2 toward the surface of the wafer W held by the spin chuck 10.

In this example, the narrow portion L2 has a shape (generally cylindrical shape) such that the area of a cross section (diameter of a generally round cross section) thereof taken perpendicularly to the deionized water discharging direction is generally constant at each portion along the deionized water discharging direction. The divergent portion M2 is continuous from an end of the narrow portion L2 on the side of the spin chuck 10 and has a shape (generally truncated conical shape) such that the area of a cross section (diameter of a generally round cross section) thereof taken perpendicularly to the deionized water discharging direction increases toward the spin chuck 10.

As described above, the nitrogen gas flowing from the gas outlet port 36 toward the wafer W is prevented from widely diverging outward in the narrow portions L1, L2. Thus, the deionized water discharged from the treatment liquid outlet port 41 is confined in a limited region, so that the deionized water and the nitrogen gas are efficiently mixed with each other (collide with each other). Therefore, deionized water droplets having smaller diameters are efficiently generated.

The flow of the nitrogen gas thus narrowed in the middle thereof is effectively forced ahead by the nitrogen gas successively discharged from the gas outlet port 36, so that the nitrogen gas can reach the wafer W without significant deceleration. Since the deionized water droplets are carried together with the nitrogen gas discharged from the gas outlet port 36, the deionized water droplets can also reach the wafer W without significant deceleration.

That is, the deionized water droplets have a kinetic energy corresponding to the flow rate of the nitrogen gas charged into the bifluid nozzle 2 to impinge on the wafer W without significantly depending on the distance between the bifluid nozzle 2 and the surface of the wafer W. Thus, the kinetic energy is applied to particles adhering on the surface of the wafer W, whereby the particles are removed. Therefore, the surface of the wafer W is efficiently cleaned.

Further, the bifluid nozzle 2 in this embodiment stabilizes the spouting direction of the deionized water droplets, so that the cleaning region on the wafer W held by the spin chuck 10 is stabilized. Therefore, the wafer W can uniformly be cleaned.

The following Table 1 shows the results of a cleaning test performed by the present inventors with varying the sizes or the like of the bifluid nozzle 2 having the arrangement described above.

In “Comparative Example”, the gas outlet port 36 has an outer diameter a=3.5 mm and a width c=0.3 mm, and the treatment liquid outlet port 41 has a diameter b=2.9 mm. In “Example 1”, the sizes are a=2.2 mm, b=2.1 mm, and c=0.05 mm. Furthermore, in “Example 2”, the sizes are a=2.5 mm, b=2.3 mm, and c=0.1 mm.

TABLE 1

| | | Nitrogen gas flow | | Droplet | Droplet density | | Number of | Number of |
|---|---|---|---|---|---|---|---|---|
| | Height | rate | Cleaning area | diameter | (×10⁷) | | damages | damages |
| Nozzle | [mm] | [L/min] | [mm²] | [μm] | [droplets/min · mm²] | Removal ratio | (1st wafer) | (2st wafer) |
| Comparative | 3 | 31 | 50.3 | 34 | 9.67 | 50% | — | 1028 |
| Example | 6 | 33 | 66 | 33 | 8.06 | Constant | 103 | 1115 |
| | 10 | 35 | 120.2 | 32 | 4.85 | treatment | 133 | 1484 |
| | 20 | 45 | 205 | 27 | 4.73 | period | 207 | 1596 |
| Example 1 | 3 | 13 | 28.3 | 20 | 84.43 | | — | 237 |
| | 10 | 14 | 129.6 | 20 | 18.42 | | — | 631 |
| Example 2 | 3 | 15 | 28.3 | 23 | 55.52 | | 46 | 448 |
| | 6 | 16 | 47.1 | 23 | 33.31 | | 72 | 608 |
| | 10 | 17 | 91.9 | 23 | 17.08 | | 77 | 753 |
| | 20 | 18 | 150.8 | 22 | 9.16 | | — | 1064 |

In Comparative Example, a test was performed while the height of the bifluid nozzle 2 from the surface of the wafer W was individually set to 3 mm, 6 mm, 10 mm, and 20 mm, and each of the nitrogen gas flow rates was adjusted so as to obtain a removal ratio of 50%. In each case, the deionized water flow rate was set to 100 ml/min. In Example 1, a test was performed while the height of the bifluid nozzle 2 from the surface of the wafer W was individually set to 3 mm and 10 mm, and each of the nitrogen gas flow rates was adjusted so as to obtain a removal ratio of 50%. In each case, the deionized water flow rate was set to 100 ml/min. In Example 2, a test was performed while the height of the bifluid nozzle 2 from the surface of the wafer W was individually set to 3 mm, 6 mm, 10 mm, and 20 mm, and each of the nitrogen gas flow rates was adjusted so as to obtain a removal ratio of 50%. In each case, the deionized water flow rate was set to 100 ml/min. Thus, the cleaning area, droplet diameter and droplet density (on a wafer W), and the number of damages to a pattern on the wafer W were examined under the conditions which can provide the same removal ratios.

“Removal ratio” herein refers to a ratio of fine particles removed from a wafer W having the fine particles previously adhered thereto. Specifically, the number of particles N₀ on a surface of a wafer W is measured. Subsequently, particles (Si₃N₄ particles) are adhered thereto, and then, the number of particles N₁ on the surface of the wafer W is measured. Further, cleaning is performed, and the number of particles N₂ on the surface of the wafer W is measured. This removal ratio can be calculated by the following equation:

Removal ratio(%)=100×(N₁−N₂)/(N₁−N₀)

The “height” of the bifluid nozzle 2 from a surface of a wafer W refers to the height from the surface of the wafer W to a gas-liquid mixing point of the bifluid nozzle 2. Strictly, the gas-liquid mixing point is located about 2 mm downward from the lower end of the bifluid nozzle 2. However, it can be regarded as being substantially in the same position as the lower end of the bifluid nozzle 2 (i.e., the position of the gas outlet port 36 and the treatment liquid outlet port 41). The gas-liquid mixing point should be located above the surface of the wafer W, whereby the lower limit of the “height” is determined. There is no physical factor to specify the upper limit thereof.

The upper limit of the “nitrogen gas flow rate” depends on the structure of the nozzle. That is, the nozzles used in Examples 1 and 2 have a smaller upper limit of the flow rate than that in Comparative Example. The nitrogen gas flow rate is controlled so that an intended removal ratio (for example, 50%) is obtained as described above.

“Cleaning area” is the size of the region (reach region; cleaning region) where a jet flow of the liquid droplets generated by the bifluid nozzle 2 reaches a surface of a wafer W. This reach region is circular, so that the cleaning area can be obtained by measuring the diameter thereof. The diameter of the reach region may be directly measured with a ruler, or indirectly measured in the following manner: an annular (strip-like) region on the wafer W is cleaned by a jet flow of liquid droplets from the bifluid nozzle 2 while the wafer W is rotating, and the width of the annular region is measured with a ruler. The cleaning area can be adjusted in accordance with the “height” of the bifluid nozzle 2. That is, the higher the height thereof is, the wider the jet flow of the liquid droplets spreads, resulting in larger cleaning area.

“Droplet diameter” is an average particle size of a liquid droplet, and herein refers to a volume median diameter (mean volume diameter). The volume median diameter is a measure of a liquid droplet particle size by the volume of a liquid sprayed from the bifluid nozzle 2. When the sum of the volumes of liquid droplets having diameters greater than a certain diameter accounts for 50% of the total volume of all the observed liquid droplets (that is, the sum of the volumes of liquid droplets having diameters smaller than the certain diameter accounts for 50% of the total volume of all the observed liquid droplets), the diameter is called a volume median diameter. The volume median diameter can be measured using a particle size distribution measuring apparatus of a laser diffraction type, or the like.

With the nozzle used in Comparative Example, the droplet diameter decreases as the nitrogen gas flow rate increases. In contrast, with the nozzles used in Examples 1 and 2, the droplet diameter is little dependent on the nitrogen gas flow rate. Therefore, there is an advantage that the nozzles in Examples 1 and 2 can maintain a droplet diameter even though the nitrogen gas flow rate slightly varies.

“Droplet density” refers to the number of liquid droplets which reaches a unit area (here, 1 square millimeter) on the surface of the wafer W per unit time (here, for 1 minute). The droplet density can be calculated based on the measurement results of the cleaning area and the volume median diameter, and the flow rate of deionized water charged into the bifluid nozzle 2. In the case of the nozzles used in Examples 1 and 2, the droplet diameter is little dependent on the nitrogen gas flow rate, so that the droplet density is thought to be affected by the “height” of the nozzle. That is, lowered height of the nozzle leads to a corresponding increase in the droplet density.

The test was performed using a first wafer having a first resist pattern formed on a surface thereof and a second wafer having a second resist pattern on a surface thereof. The second resist pattern is weak as compared with the first resist pattern. Each of the first and second resist patterns is formed with a line (trace) having a width of 180 nm at a space (interval) having the same width of 180 nm.

“Number of damages” refers to a total number of pattern falling and pattern jumping (lacking) on a wafer. Criteria for evaluating the number of damages were established such that the first wafer has damages of not more than 100 and the second wafer has damages of not more than 1000.

As understood from the descriptions of FIGS. 4 and 5, the higher the height of the bifluid nozzle 2 is, the larger the cleaning area becomes, which leads to a corresponding decrease in the droplet density on the surface of the wafer W. Moreover, the nitrogen gas flow rate required to achieve a desired removal ratio increases. In the case where the “height” of a nozzle used in Example 2 is 20 mm, the nozzle “height” results in failure (see Table 1) in accordance with the above criteria. This suggests that due to the elevation of the nozzle height, the droplet density has decreased, thereby causing insufficient effect of removing foreign matter. In order to compensate for this insufficiency, the nitrogen gas flow rate has been increased, resulting in increase in damage. Therefore, the nozzle may have a height of preferably not more than 20 mm, and more preferably not more than 10 mm. Furthermore, the nitrogen gas flow rate of not more than 17 liters/min may be effective in suppression of damage.

In Comparative Example, even when the height of the bifluid nozzle 2 is lowered to 6 mm, the nitrogen gas flow rate required to achieve 50% removal ratio is 33 liters/min. At this time, the droplet diameter is 33 μm, and the droplet density is 8.06×10⁷ droplets/min·mm². In this case, the first wafer has 103 damages, and the second wafer has 1115 damages. Thus, unacceptable damage is caused to the pattern on the surface of the wafer W.

On the other hand, in the case of the bifluid nozzles 2 used in Examples 1 and 2, even when the height of the bifluid nozzle 2 is raised to 10 mm, the nitrogen gas flow rate required to achieve 50% removal ratio is about 14 to 17 liters/min. At this time, the droplet diameters are 20 μm and 23 μm, respectively, and the droplet densities are 18.42×10⁷ droplets/min·mm 2 and 17.08×10⁷ droplets/min·mm², respectively. That is, a small gas flow rate can provide micro liquid droplets having a diameter of about 20 μm. Therefore, it is not necessary to increase the flow rate. Accordingly, the second wafer has 631 damages in Example 1, and the first wafer has 77 damages in Example 2. Both of the damages are within the acceptable ranges.

Thus, by using the bifluid nozzles used in Examples 1 and 2, the nitrogen gas flow rate can be suppressed to a small flow rate, and liquid droplets having small diameters can be supplied to the surface of the wafer W at high density. As a result, the damage to the pattern on the surface of the wafer W can be suppressed. Of course, the amount of the nitrogen gas used can also be reduced.

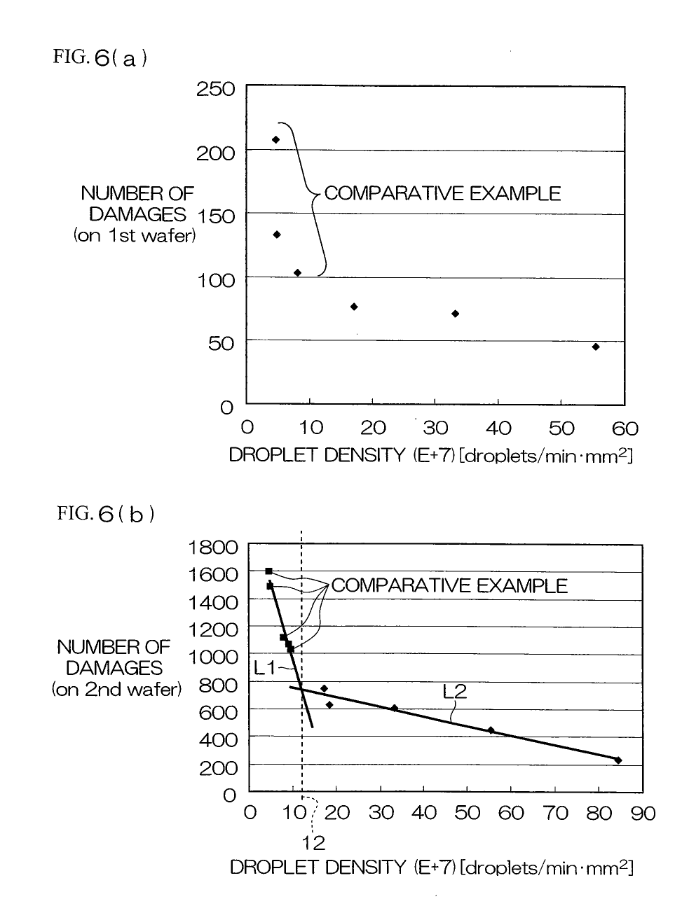

FIG. 6(a) illustrates a relationship between the droplet density and the number of patterns damaged on a first wafer, and FIG. 6(b) illustrates a relationship between the droplet density and the number of patterns damaged on a second wafer. It can be seen from these figures that the number of damages has decreased when the droplet density is not less than 10⁸ droplets/min·mm². Furthermore, in a region having a droplet density of less than 10⁸ droplets/min·mm² (more specifically, a region having a droplet density of less than 1.2×10⁸ droplets/min·mm²), the number of damages is significantly dependent on the droplet density. In contrast, in a region having a droplet density of not less than 10⁸ droplets/min·mm² (particularly, a region having a droplet density of not less than 1.2×10⁸ droplets/min·mm²), a tendency that the number of damages decreases as the droplet density increases can be seen while significant droplet density dependence cannot be seen. In other words, the region having a droplet density of not less than 10⁸ droplets/min·mm² (particularly, the region having a droplet density of not less than 1.2×10⁸ droplets/min·mm²) may be said as a region where the number of damages is relatively less dependent on the droplet density. As understood from the reference lines L1 and L2 shown in FIG. 6 (b), the number of damages is significantly dependent on the droplet density in the region having a droplet density of less than 1.2×10⁸ droplets/min·mm², and is less dependent thereon in the region having a droplet density of not less than 10⁸ droplets/min·mm². Therefore, the foreign matter removing processing can preferably be performed under the conditions that the droplet density is not less than 1.2×10⁸ droplets/min·mm².

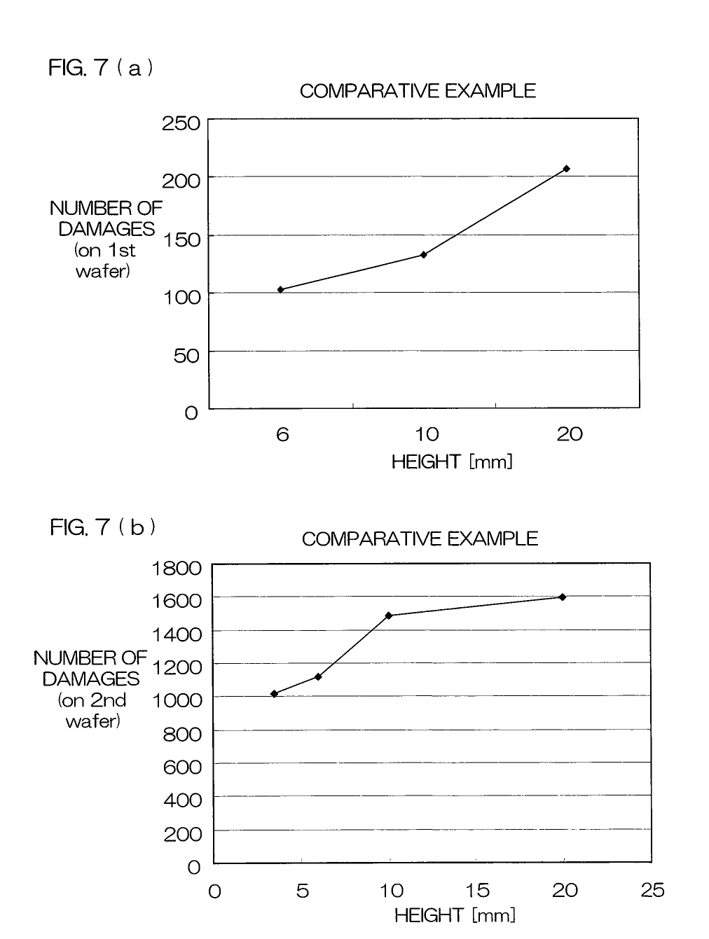

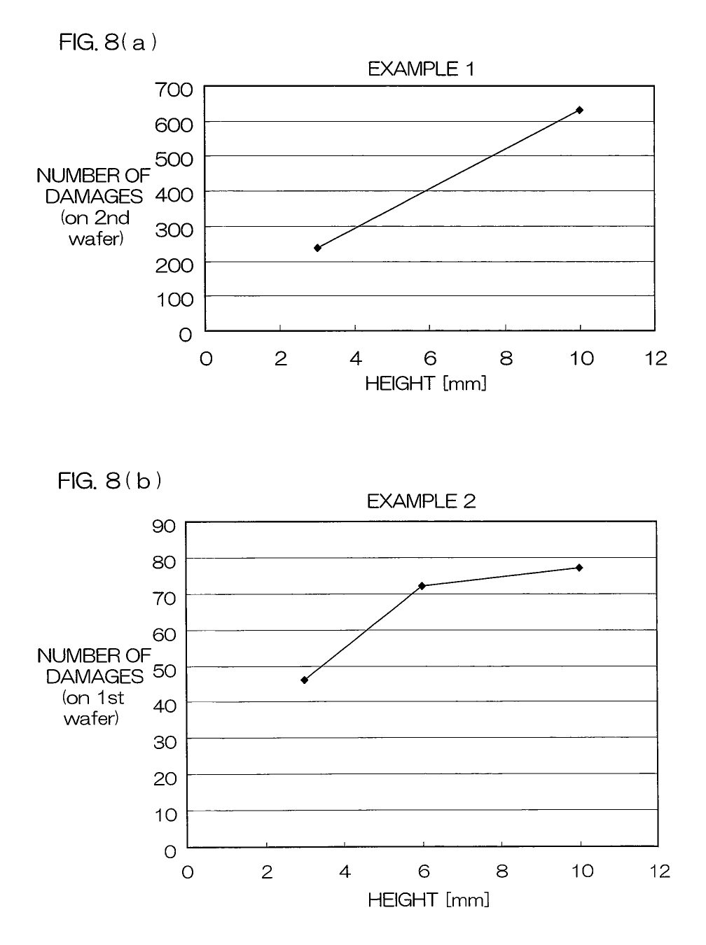

FIG. 7(a) illustrates a relationship between the nozzle height and the number of patterns damaged on a first wafer in Comparative Example described above, and FIG. 7(b) illustrates a relationship between the nozzle height and the number of patterns damaged on a second wafer in Comparative Example described above. Further, FIG. 8(a) illustrates a relationship between the nozzle height and the number of patterns damaged on a second wafer in Example 1 described above, and FIG. 8(b) illustrates a relationship between the nozzle height and the number of patterns damaged on a first wafer in Example 2 described above. From these figures, the following relationship can be grasped: elevation of the nozzle height makes the cleaning area larger, which leads to a corresponding decrease in the droplet density. To compensate for the cleaning capability, the nitrogen gas flow rate is increased, whereby the number of damages increases.

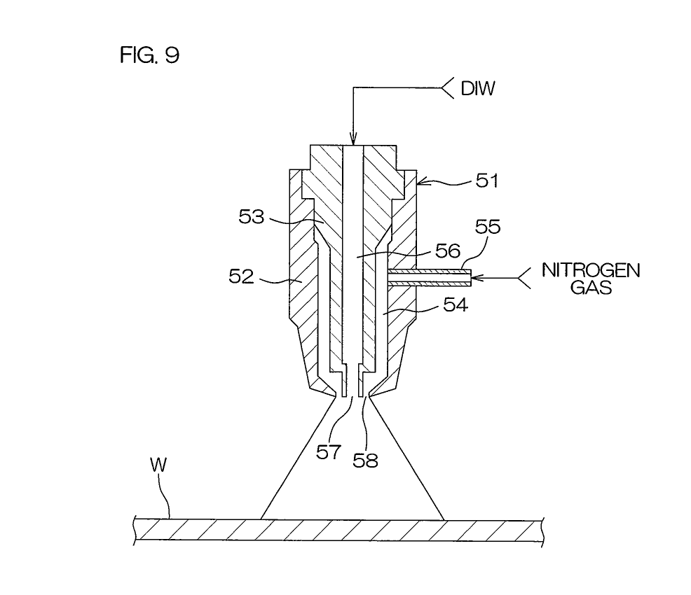

In the foregoing, an embodiment of the present invention has been discussed, but the present invention can also be embodied in a different manner. For example, in the embodiment described above, the bifluid nozzle having a construction of spirally discharging a nitrogen gas from the gas outlet port 36 is exemplified, but the gas discharged from the gas outlet port does not need to generate a spiral flow. That is, the present invention can also be applied to a substrate treatment apparatus using a bifluid nozzle (see, for example, FIG. 9) having a construction such that a gas discharged from a gas outlet port is sprayed radially to a treatment liquid discharged from a treatment liquid outlet port.

The pure water obtained through a process other than ion exchange, such as distilled water, may be used instead of deionized water. Other pure water having suitable kind and content of impurities can be used depending on the purpose.

The treatment liquid to be discharged from the bifluid nozzle 2 is not limited to pure water (cleaning liquid), but may be an etching liquid, for example. In this case, the etching liquid and the nitrogen gas are efficiently mixed with each other by the bifluid nozzle 2, whereby droplets of the etching liquid having smaller diameters are generated. Thus, the surface of the wafer W can be etched without any damage to the wafer W.

Since the nitrogen gas discharged from the gas outlet port 36 does not widely diverge outward, droplet of an etching liquid with a great kinetic energy are caused to impinge on the surface of the wafer W, so that the surface thereof can be etched efficiently.

The bifluid nozzle 2 may be disposed in a position such that the center axis Q thereof and the normal line of the wafer W obliquely intersect each other so that the major flow direction of the deionized water droplets spouted from the bifluid nozzle 2 (the center axis of the spiral flow) is inclined with respect to the wafer W.

Embodiments of the present invention have been discussed in detail, but these embodiments are mere specific examples for clarifying the technical contents of the present invention. Therefore, the present invention should not be construed as limited to these specific examples. The spirit and scope of the present invention are limited only by the appended claims.

This application corresponds to Japanese Patent Application No. 2006-17967 filed on Jan. 26, 2006 and Japanese Patent Application No. 2006-294470 filed on Oct. 30, 2006 with Japanese Patent Office, the disclosures of which are incorporated here by reference.

What is claimed is:

1. A substrate treatment apparatus, comprising:
a substrate holder mechanism for holding a substrate to be treated; and
a bifluid nozzle having a casing, a liquid outlet port for discharging a treatment liquid, and a gas outlet port for discharging gas, the bifluid nozzle being adapted to introduce the treatment liquid and the gas into the casing, to generate droplets of the treatment liquid by mixing the treatment liquid discharged from the liquid outlet port with the gas discharged from the gas outlet port outside the casing, and to supply the liquid droplets on a surface of the substrate held by the substrate holder mechanism,
wherein a density of the liquid droplets supplied from the bifluid nozzle on the surface of the substrate is not less than 10⁸ droplets/square millimeter per minute.

2. A substrate treatment apparatus according to claim 1, wherein the density of the liquid droplets supplied from the bifluid nozzle on the surface of the substrate is not less than 1.2×10⁸ droplets/m² per minute.

3. A substrate treatment apparatus according to claim 1, wherein the gas outlet port is in the form of an annular shape surrounding the liquid outlet port, and the gas outlet port of the annular shape has an outer diameter of not less than 2 mm nor more than 3.5 mm and a width of not less than 0.05 mm nor more than 0.2 mm.

4. A substrate treatment apparatus according to claim 1, further comprising a gas supplying mechanism for supplying the gas to the casing at a flow rate of not more than 17 liters per minute.

5. A substrate treatment apparatus comprising:
a substrate holder mechanism for holding a substrate to be treated, and
a bifluid nozzle having a casing, a liquid outlet port for discharging a treatment liquid, and a gas outlet port for discharging gas, the bifluid nozzle being adapted to introduce the treatment liquid and the gas into the casing, to generate droplets of the treatment liquid by mixing the treatment liquid discharged from the liquid outlet port with the gas discharged from the gas outlet port outside the casing, and to supply the liquid droplets on a surface of the substrate held by the substrate holder mechanism,
wherein the gas outlet port is in the form of an annular shape surrounding the liquid outlet port, and the gas outlet port of the annular shape has an outer diameter of not less than 2 mm nor more than 3.5 mm, and a width of not less than 0.05 mm nor more than 0.2 mm.

6. A substrate treatment apparatus according to claim 5, wherein the bifluid nozzle is disposed at a position spaced less than 20 mm apart from the surface of the substrate held by the substrate holder mechanism when the droplets of the treatment liquid is supplied to the substrate.

7. A substrate treatment apparatus according to claim 5, further comprising a controller for controlling flow rates of the treatment liquid and the gas each supplied to the casing and the distance between the bifluid nozzle and the substrate surface so that a density of the liquid droplets supplied from the bifluid nozzle on the substrate surface is not less than 10⁸ droplets/m² per minute.

8. A substrate treatment apparatus according to claim 7, wherein the controller is adapted to control the flow rates of the treatment liquid and the gas each supplied to the casing and the distance between the bifluid nozzle and the substrate surface so that the density of the liquid droplets supplied from the bifluid nozzle on the substrate surface is not less than 1.2×10⁸ droplets/m² per minute.

9. A substrate treatment apparatus according to claim 1, wherein a volume median diameter of the liquid droplets supplied from the bifluid nozzle is not more than 25 μm.

10. A substrate treatment apparatus according to claim 5, wherein a volume median diameter of the liquid droplets supplied from the bifluid nozzle is not more than 25 μm.

11. A substrate treatment apparatus according to claim 1, wherein a reach region of the liquid droplets supplied from the bifluid nozzle on the substrate surface has a diameter of not less than 5 mm nor more than 15 mm.

12. A substrate treatment apparatus according to claim 5, wherein a reach region of the liquid droplets supplied from the bifluid nozzle on the substrate surface has a diameter of not less than 5 mm nor more than 15 mm.

13. A substrate treatment apparatus according to claim 1, wherein the bifluid nozzle has a spiral flow generating portion provided in a gas channel leading from a gas inlet port to the gas outlet port in the casing, so as to generate a spiral flow which sheathes a treatment liquid flow discharged from the treatment liquid outlet port along a treatment liquid discharging direction.

14. A substrate treatment apparatus according to claim 5, wherein the bifluid nozzle has a spiral flow generating portion provided in a gas channel leading from a gas inlet port to the gas outlet port in the casing, so as to generate a spiral flow which sheathes a treatment liquid flow discharged from the treatment liquid outlet port along a treatment liquid discharging direction.

15. A substrate treatment method, comprising the steps of:
introducing a treatment liquid into a casing of a bifluid nozzle;
introducing gas into the casing of the bifluid nozzle;
generating droplets of the treatment liquid by discharging the gas from a gas outlet port of the bifluid nozzle while the liquid is discharged from a liquid outlet port of the bifluid nozzle, and mixing the discharged gas and liquid; and
supplying the generated liquid droplets on a surface of a substrate, to provide a droplet density on the substrate surface of not less than 10⁸ droplets/m² per minute.

16. A substrate treatment method according to claim 15, wherein the step of supplying the liquid droplets on the surface of the substrate comprises a step of providing the density of the liquid droplets supplied from the bifluid nozzle on the surface of the substrate of not less than 1.2×10⁸ droplets/m² per minute.

17. A substrate treatment method according to claim 15, wherein the step of introducing the gas into the casing of the bifluid nozzle comprises a step of supplying the gas to the casing at a flow rate of not more than 17 liters per/minute.
